(19) United States
(12) Patent Application Publication
(10) Pub. No.: US 2024/0219810 A1
(43) Pub. Date: Jul. 4, 2024

(54) CAMERA MODULE WITH AN IRIS MODULE

(71) Applicant: SAMSUNG ELECTRO-MECHANICS CO., LTD., Suwon-si (KR)

(72) Inventors: Jae Hyung HAN, Suwon-si (KR); Nam Ki PARK, Suwon-si (KR); Hong Joo LEE, Suwon-si (KR); Jong Woo HONG, Suwon-si (KR); Ji Buem CHUN, Suwon-si (KR)

(73) Assignee: SAMSUNG ELECTRO-MECHANICS CO., LTD., Suwon-si (KR)

(21) Appl. No.: 18/347,282

(22) Filed: Jul. 5, 2023

(30) Foreign Application Priority Data
Dec. 28, 2022 (KR) 10-2022-0187251
Mar. 2, 2023 (KR) 10-2023-0027958

(51) Int. Cl. G03B 9/22; G03B 17/12; H02K 1/08; H04N 23/54

(52) U.S. Cl. CPC G03B 9/22; G03B 17/12; H02K 1/08; H04N 23/54

(57) ABSTRACT

An iris module includes a base, a plurality of blades disposed on the base, and an iris driving unit including a magnet unit configured to linearly reciprocate on the base and drive the plurality of blades. The magnet unit includes a driving magnet with an odd number of polarized poles along a movement path of the magnet unit.

### CROSS-REFERENCE TO RELATED APPLICATION(S)

This application claims the benefit under 35 USC § 119(a) of Korean Patent Application No. 10-2022-0187251, filed on Dec. 28, 2022, and Korean Patent Application No. 10-2023-0027958, filed on Mar. 2, 2023, in the Korean Intellectual Property Office, the entire disclosures of which are incorporated herein by reference for all purposes.

### BACKGROUND

### 1. Field

The present disclosure relates to a camera module with an iris module.

### 2. Description of Related Art

Recently, camera modules have been standardly employed in portable electronic devices such as smartphones, tablet PCs, and laptop computers. In the case of a general digital camera, a mechanical iris is provided to change the amount of incident light therein, according to the image capturing environment, but in the case of a camera module used in a small product such as a portable electronic device, it may be difficult to separately provide an iris due to structural characteristics and space limitations.

For example, the weight of the camera module may be increased due to various parts for driving the diaphragm, and thus the autofocus function may deteriorate. In addition, when the diaphragm is provided with a power connection unit, such as a coil for driving the diaphragm, a problem, such as the power connection unit being caught according to the vertical movement of the lens during autofocusing, may occur.

In addition, since an iris module with various aperture diameters may be desired in a narrow space, a correct aperture diameter may be inhibited due to the position of the driving unit.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an iris module includes a base, a plurality of blades disposed on the base, and an iris driving unit including a magnet unit configured to linearly reciprocate on the base and drive the plurality of blades. The magnet unit includes a driving magnet with three polarized poles along a movement path of the magnet unit.

The odd number of polarized poles may be three.

The plurality of blades may be configured to form three different aperture sizes when combined.

A yoke disposed on the base may face the driving magnet along the movement path of the magnet unit.

The magnet unit may be fixable to three different positions on the movement path by attractive force between the driving magnet and the yoke.

The yoke may have one expansion portion in which a height of a portion opposite to the driving magnet, in an optical axis direction, is greater than heights of other portions.

The expansion portion may be disposed in a middle portion of the movement path of the magnet unit.

The yoke may have holding portions facing sides of the driving magnet or having a height in the optical axis direction, greater than other portions, on both ends, respectively.

A camera module may include a housing having a lens module, and the iris module of described above coupled to the lens module.

In another general aspect, a camera module includes a housing having a lens module; and an iris module, coupled to an upper portion of the lens module, including a base, a plurality of blades disposed on the base, and an iris driving unit including a magnet unit configured to linearly reciprocate on the base and drive the plurality of blades. The magnet unit includes a driving magnet with an odd number of polarized poles along a movement path of the magnet unit, and driving coils are disposed along the movement path of the magnet unit to face the driving magnet.

The odd number of polarized poles may be three.

The driving coils may be two driving coils disposed opposite to two poles of the driving magnet, simultaneously and respectively.

A yoke may be disposed on the base faces the driving magnet along the movement path of the magnet unit.

The magnet unit may be fixable to three different positions on the movement path by attractive force between the driving magnet and the yoke.

The yoke may have one expansion portion in which a height of a portion opposite to the driving magnet in an optical axis direction is greater than heights of other portions.

The expansion portion may be disposed between the two driving coils.

A position sensor configured to sense a position of the magnet unit may be disposed in the housing.

In another general aspect, a camera module includes a housing, a lens module accommodated in the housing, and an iris module configured to form three differently sized apertures with a plurality of blades. On surfaces of the housing parallel to an optical axis direction, a first OIS driving coil is disposed to drive the lens module in a first direction perpendicular to the optical axis direction, a second OIS driving coil is disposed to drive the lens module in the optical axis direction and a second direction perpendicular to the first direction, an AF driving coil is disposed to drive the lens module in the optical axis direction, and two iris driving coils are disposed to drive the plurality of blades, respectively.

Other features and aspects will be apparent from the following detailed description, the drawings, and the claims.

### BRIEF DESCRIPTION OF DRAWINGS

FIG. 1 is a perspective view of an example of a camera module, according to one or more embodiments.

FIG. 2 is an exploded perspective view of an example of a camera module according to one or more embodiments.

FIG. 3 is a partial perspective view of an example of a camera module according to one or more embodiments.

FIG. 4 is an exploded perspective view of an example of an iris module according to one or more embodiments.

FIGS. 5A to 5C are perspective views illustrating a state in which an example of an iris module is driven to change a diameter of an entrance hole.

FIGS. 6 and 7 are reference views illustrating a positional relationship between an example of a yoke and a driving magnet according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

An aspect of the present disclosure is to provide an iris module capable of accurately implementing three diaphragm diameters by fixing a driving unit in an accurate position, to significantly reduce the weight increase due to the adoption of the iris module, and a camera module including the same.

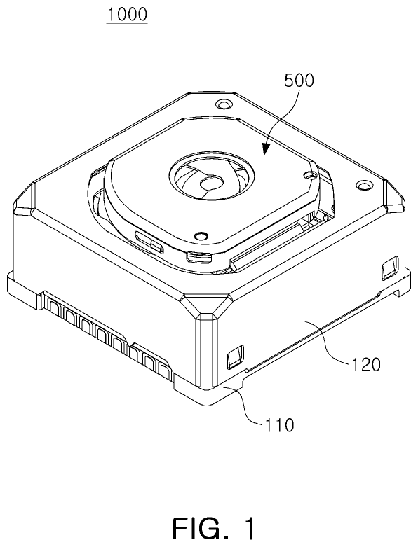

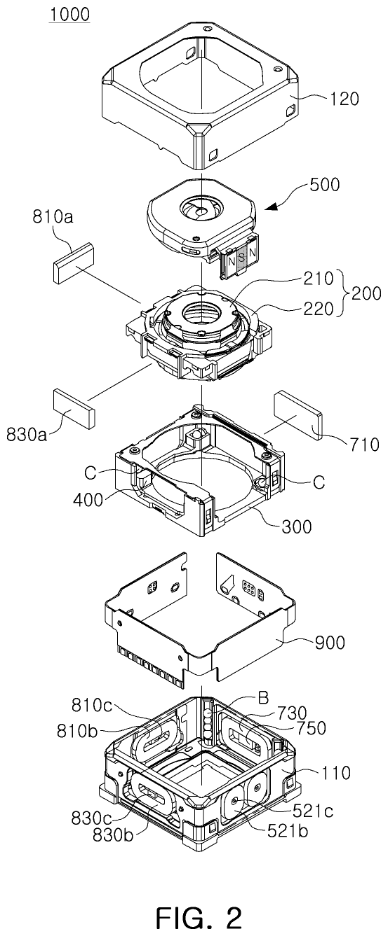

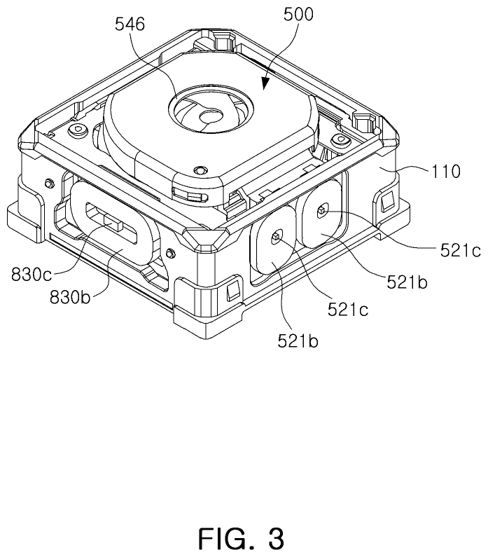

FIG. 1 is a perspective view of an example of a camera module according to one or more embodiments. FIG. 2 is an exploded perspective view of an example of a camera module according to one or more embodiments. FIG. 3 is a perspective view illustrating a portion of an example of a camera module (case removed) according to one or more embodiments.

Referring to FIGS. 1 to 3, a camera module 1000, according to one or more embodiments, includes a lens module 200, a carrier 300, a guide portion 400, an iris module 500, a housing 110, and a case 120.

The lens module 200 may include a lens barrel 210 having a plurality of lenses for photographing a subject and a holder 220 accommodating the lens barrel 210. The plurality of lenses is disposed inside of the lens barrel 210 along the optical axis. The lens module 200 is accommodated in the carrier 300.

The lens module 200 is configured to be movable in an optical axis direction for autofocus. For example, the lens module 200 may be moved along with the carrier 300 in the optical axis direction by a focus adjusting unit.

The focus adjusting unit may include a magnet 710 and a coil 730, for example, an AF driving coil, generating driving force in the direction of the optical axis. In addition, a position sensor 750, for example, a hall sensor, may be provided to sense the optical axis direction position of the lens module 200, for example, the carrier 300.

The magnet 710 is mounted on the carrier 300. For example, the magnet 710 may be mounted on one side of the carrier 300.

The coil 730 and the position sensor 750 are mounted on the housing 110. For example, the coil 730 and the position sensor 750 may be fixed to the housing 110 to face the magnet 710. The coil 730 and the position sensor 750 may be provided on a substrate 900, and the substrate 900 may be mounted on the housing 110.

The magnet 710 is a moving member mounted on the carrier 300 and moves in the optical axis direction together with the carrier 300. The coil 730 and the position sensor 750 are fixed members fixed to the housing 110.

When power is applied to the coil 730, the carrier 300 may be moved in the optical axis direction by electromagnetic influence between the magnet 710 and the coil 730. Also, the position sensor 750 may sense the optical axis direction position of the carrier 300.

Since the lens module 200 is accommodated in the carrier 300, the lens module 200 is also moved along with the carrier 300 in the optical axis direction by the movement of the carrier 300.

A rolling member B is disposed between the carrier 300 and the housing 110 to reduce friction between the carrier 300 and the housing 110 when the carrier 300 is moved. The rolling member (B) may be in the form of a ball.

The rolling member (B) is disposed on both sides of the magnet 710 (or the coil 730).

A yoke may be mounted on the substrate 900. For example, the yoke may be disposed to face the magnet 710 with the coil 730 interposed therebetween.

Between the yoke and the magnet 710, an attractive force acts in a direction perpendicular to the optical axis direction.

Therefore, the rolling member (B) may maintain contact with the carrier 300 and the housing 110 by the attractive force between the yoke and the magnet 710.

In addition, the yoke also functions to focus the magnetic force of the magnet 710. Accordingly, leakage magnetic flux may be prevented from occurring.

For example, the yoke and the magnet 710 form a magnetic circuit.

On the other hand, to compensate for image shake caused by a user's hand shake or the like, the lens module 200 may be moved in a first direction, perpendicular to the optical axis, and in a second direction, perpendicular to the optical axis and the first direction.

For example, the shake correction unit compensates for the shake by providing a relative displacement corresponding to the shake to the lens module 200 when a shake occurs during image capture due to a user's hand shake.

The guide portion 400 is accommodated in the carrier 300 to be disposed in an upper portion thereof in the optical axis direction. Then, the holder 220 is disposed on an upper portion of the guide portion 400. In addition, a ball member C serving as a rolling bearing may be provided between the carrier 300 and the guide portion 400 in the optical axis direction and between the guide portion 400 and the holder 220 in the optical axis direction.

When the lens module 200 is moved in the first and second directions perpendicular to the optical axis, the guide portion 400 is configured to guide the lens module 200.

For example, the lens module 200 moves relative to the guide portion 400 in a first direction, and the guide portion 400 and the lens module 200 may be configured to move together in the second direction within the carrier 300.

The shake correction unit includes a plurality of magnets 810a and 830a and a plurality of coils 810b and 830b, for example, first and second OIS driving coils, generating a driving force for image stabilization. In addition, a plurality of position sensors 810c and 830c, for example, a hall sensor, may be provided to sense the positions of the lens module 200 in the first and second directions.

Among the plurality of magnets 810a and 830a and the plurality of coils 810b and 830b, a portion 810a of the magnets and a portion 810b of the coils are disposed to face each other in a first direction to generate a driving force in the first direction, and the remaining magnet 830a and the remaining coil 830b are disposed to face each other in the second direction to generate a driving force in the second direction.

The plurality of magnets 810a and 830a are mounted on the lens module 200, and the plurality of coils 810b and 830b and the plurality of position sensors 810c and 830c, facing the plurality of magnets 810a and 830a, are fixed to the housing 110. For example, the plurality of coils 810b and 830b and the plurality of position sensors 810c and 830c are provided on the substrate 900, and the substrate 900 is mounted on the housing 110.

The plurality of magnets 810a and 830a are moving members that move in the first and second directions together with the lens module 200, and the plurality of coils 810b and 830b and the plurality of position sensors 810c and 830c are fixed members fixed to the housing 110.

On the other hand, in the present disclosure, a ball member c supporting the guide portion 400 and the lens module 200 is provided. The ball member (c) serves to guide the guide portion 400 and the lens module 200 in the image stabilization process.

The ball member (c) may be provided between the carrier 300 and the guide portion 400, between the carrier 300 and the lens module 200, and between the guide portion 400 and the lens module 200.

When a driving force in the first direction is generated, the ball member (c) disposed between the carrier 300 and the guide portion 400 and between the carrier 300 and the lens module 200 rolls in the first direction. Accordingly, the ball member (c) guides the movement of the guide portion 400 and the lens module 200 in the first direction.

In addition, when a driving force in the second direction is generated, the ball member (c) disposed between the guide portion 400 and the lens module 200 and between the carrier 300 and the lens module 200 rolls in the second direction. Accordingly, the ball member (c) guides the movement of the lens module 200 in the second direction.

The lens module 200 and the carrier 300 are accommodated in the housing 110. For example, the housing 110 has open upper and lower portions, and the lens module 200 and the carrier 300 are accommodated in the inner space of the housing 110.

A printed circuit board on which an image sensor is mounted may be disposed in a lower portion of the housing 110.

The case 120 is combined with the housing 110 to surround the outer surface of the housing 110 and serves to protect internal components of the camera module. In addition, the case 120 may function to shield electromagnetic waves.

The case 120 may shield electromagnetic waves such that the electromagnetic waves generated by the camera module do not affect other electronic components in the portable electronic device.

In addition, since portable electronic devices are equipped with various electronic components in addition to the camera module, the case 120 may shield the electromagnetic waves such that the electromagnetic waves generated from these electronic parts do not affect the camera module.

The case 120 is formed of a metal material and may be grounded to a ground pad provided on the printed circuit board, thereby shielding electromagnetic waves.

The iris module 500 is a device configured to selectively change the incident amount of light incident on the lens module 200.

For example, the iris module 500 may include a plurality of entrance holes or apertures having different sizes, for example, three. Depending on the shooting environment, light may be incident through one of the three entrance holes or apertures.

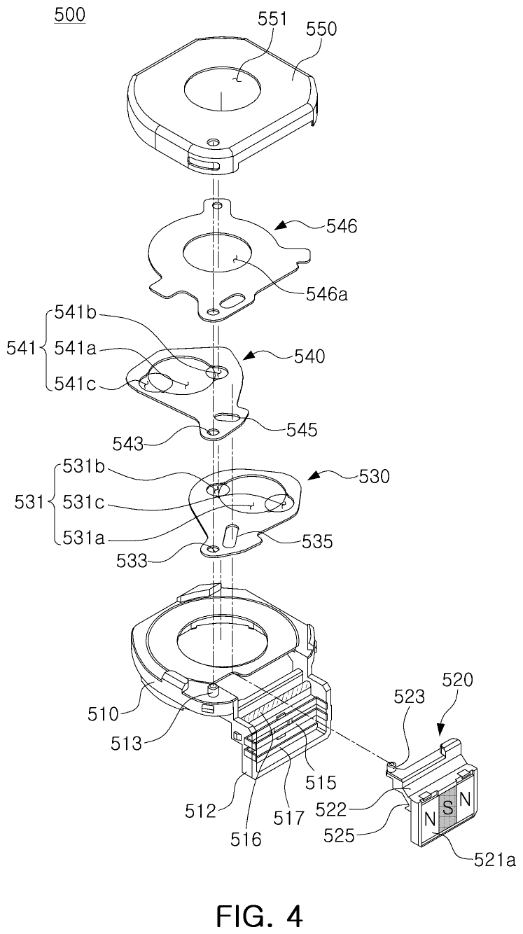

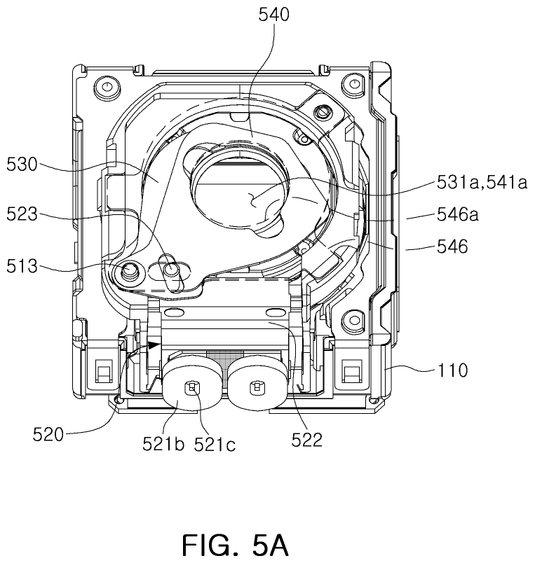

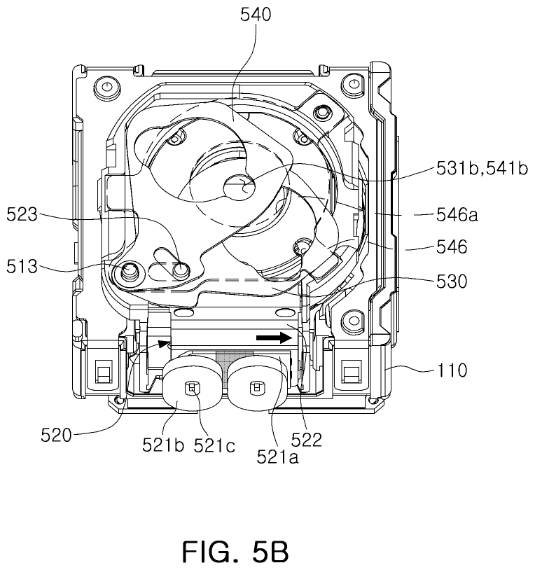

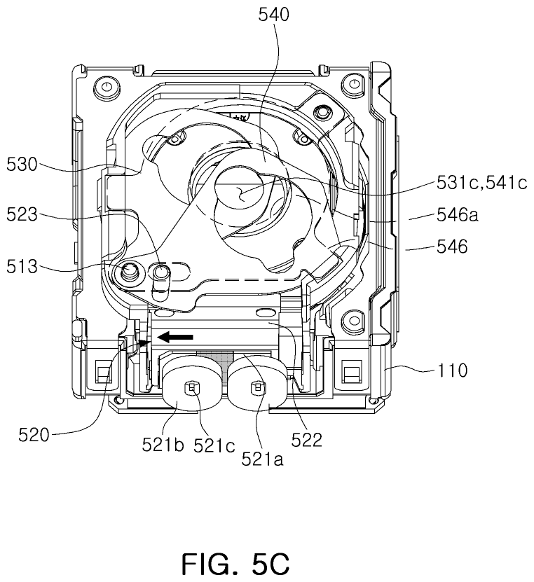

FIG. 4 is an exploded perspective view of an example of an iris module according to one or more embodiments, and FIGS. 5A to 5C are plan views illustrating examples of the iris module being driven to change the diameter of an entrance hole or aperture.

In the iris module 500, according to this example, at least two entrance holes or apertures having different sizes may be formed by overlapping at least two blades and combining through-holes provided therein. In this example, as a non-limiting example, a structure in which three entrance holes or apertures are formed using two blades will be described for reference, but the present disclosure is not limited thereto. For example, an iris module may be implemented in which three different sizes of entrance holes or apertures are formed using three or more blades.

The iris module 500 is combined with the lens module 200 and is configured to selectively change the incident amount of light incident on the lens module 200.

Since a relatively small amount of light may be incident to the lens module 200 in a high-illuminance environment and a relatively large amount of light may be incident to the lens module 200 in a low-illuminance environment, image quality may be maintained consistently under various lighting conditions.

The iris module 500 is coupled to the lens module 200 and configured to be movable together with the lens module 200 in the direction of the optical axis, the first direction, and the second direction. For example, by allowing the lens module 200 and the iris module 500 to move together during autofocusing and image stabilization, the distance therebetween does not change.

Referring to FIG. 4, the iris module 500 includes a base 510, a first blade 530, a second blade 540, and an iris driving unit (including a magnet unit 520 and a coil 521b). In addition, the iris module 500 may include a cover 550 covering the base 510, the first blade 530, and the second blade 540 and having a through-hole 551 through which light is incident.

The first blade 530 is provided with a first through-hole 531, and the second blade 540 is provided with a second through-hole 541. In addition, since the first blade 530 and the second blade 540 slide while being in contact with each other, antistatic treatment may be applied thereto to prevent the generation of triboelectricity.

In addition, the first blade 530 is provided with a first guide hole 533 and a third guide hole 535, and the second blade 540 is provided with a second guide hole 543 and a fourth guide hole 545.

The first guide hole 533 and the second guide hole 543 may have a round shape, and the third guide hole 535 and the fourth guide hole 545 may be inclined in one direction to have a long shape in one direction. In addition, the inclination directions of the third guide hole 535 and the fourth guide hole 545 may be different, e.g., opposite to each other, based on the moving direction of the magnet unit 520.

The first blade 530 and the second blade 540 convert the linear motion of the magnet unit 520 into a rotational motion and rotate based on the first protrusion 513, which is a rotation axis, respectively.

The first through-hole 531 and the second through-hole 541 may have a shape in which a plurality of through-holes (531a, 531b, and 531c) (541a, 541b, and 541c) having different diameters are connected to each other. In this example, forming three entrance holes or apertures will be described as an example. The first through-hole 531 and the second through-hole 541 may have a shape in which relatively large-diameter through-holes 531a and 541a, relatively small-diameter through-holes 531b and 541b, and relatively medium-diameter through-holes 531c and 541c are connected to each other. For example, the first through-hole 531 may have a shape in which three holes are connected as a whole. The through-holes 531a, 531b, 531c, 541a, 541b, and 541c may have a round shape or a polygonal shape.

Also, the shapes of the first through-hole 531 and the second through-hole 541 may be oriented differently, e.g., opposite to each other. For example, the first blade 530 and the second blade 540 rotate around the first protrusion 513 as a central axis in a state in which the first protrusion 513 is fitted into both the first guide hole 533 and the second guide hole 543, and considering this, the first through hole 531 and the second through hole 541 may have substantially symmetrical shapes in the circumferential direction.

The first blade 530 and the second blade 540 are coupled to the base 510 such that portions thereof overlap each other in the optical axis direction, and are configured to be respectively movable by an iris driving unit. For example, the first blade 530 and the second blade 540 may be configured to rotate in opposite directions.

In addition, portions of the first through-hole 531 and the second through-hole 541 may be configured to overlap each other in the optical axis direction. Portions of the first through-hole 531 and the second through-hole 541 may overlap each other in the optical axis direction to form an entrance hole through which light passes.

The first through-hole 531 and the second through-hole 541 may partially overlap to form a plurality of entrance holes or apertures having different diameters. For example, portions of the first through-hole 531 and the second through-hole 541 are overlapped to form relatively large-diameter entrance holes or apertures (see 531a and 541a in FIG. 5A), relatively small-diameter entrance holes or apertures (see 531b and 541b in FIG. 5B), and medium-diameter entrance holes or apertures (see 531c and 541c in FIG. 5C). For example, the entrance holes or apertures may have a round shape or a polygonal shape depending on the shapes of the first through-hole 531 and the second through-hole 541.

Accordingly, light may be incident through one of the plurality of entrance holes or apertures according to the photographing environment.

On the other hand, in the present example, the case where the size of the entrance hole is the largest may be adjusted by a gap spacer 546. The gap spacer 546 is provided adjacent to the blades 530 and 540 of the iris module 500, and may have a through-hole 546a having a smaller size than the largest entrance hole and a larger size than the medium-diameter entrance hole formed in the blades 530 and 540. In addition, the center of the through-hole 546a may be aligned with the entrance hole formed by the blades 530 and 540 in the optical axis direction.

For the convenience of descriptions, it will be described with reference to one or more embodiments in which the gap spacer 546 is provided on the upper surface of the upper blade 540 closer to the object side, but the present disclosure is not limited thereto. The gap spacer 546 may be provided on the upper surface of the upper blade 540 closer to the object side, the lower surface of the lower blade 530 closer to the image side, or in the middle thereof (between 530 and 540).

Accordingly, the largest entrance hole implemented by the iris module 500 may be the size of the through-hole 546a of the gap spacer 546. The implementation of the entrance hole with the maximum size using the gap spacer 546 is to cope with a situation in which the shape of the entrance hole formed by overlapping the blades 530 and 540 does not maintain the required shape due to tolerance or the like.

Referring to FIG. 5A, when the magnet unit 520 is positioned approximately in the middle of a movement guide portion 512 by the iris driving unit, the first blade 530 and the second blade 540 are rotated around the first protrusion 513 as an axis, and portions of the first through-hole 531 and the second through-hole 541 may overlap each other to form entrance holes or apertures 531a and 541a having a relatively largest diameter. On the other hand, in the present example, the gap spacer 546 having the through-hole 546a smaller in size than the largest entrance holes or apertures 531a and 541a formed by the first blade 530 and the second blade 540 may be provided. In this case, the largest entrance hole may be implemented by the through-hole 546a of the gap spacer 546.

Referring to FIG. 5B, when the magnet unit 520 is positioned on one side of the movement guide portion 512 by the iris driving unit, the first blade 530 and the second blade 540 are rotated around the first protrusion 513 as an axis, and portions of the first through-hole 531 and the second through-hole 541 may overlap each other to form entrance holes or apertures 531b and 541b having a relatively smallest diameter.

In addition, referring to FIG. 5C, when the magnet unit 520 is located on the other side opposite to one side of the movement guide portion 512 by the iris driving unit, the first blade 530 and the second blade 540 are rotated and moved around the first protrusion 513 as an axis, and portions of the first through-hole 531 and the second through-hole 541 may overlap each other to form entrance holes or apertures 531c and 541c having a relatively medium diameter.

The iris driving unit includes the magnet unit 520 disposed on the base 510 to be movable in a direction perpendicular to the optical axis direction, and the coil 521b, for example, an iris driving coil, fixed to the housing 110 to face the magnet unit 520. The driving magnet 521a driving the iris may be polarized with three poles, and the two driving coils 521b may be disposed to face each other at the same time as the two poles of the driving magnet 521a. For example, when the driving magnet 521a is sequentially magnetized to the NSN pole, the NS pole on the left side may face the drive coil provided on the left side, and the SN pole on the right side may face the drive coil provided on the right side.

The coil 521b is provided on the substrate 900, and the substrate 900 is fixed to the housing 110. The substrate 900 may be electrically connected to a printed circuit board attached to the bottom of the camera module 1000.

In addition, in this example, when the magnet unit 520 is linearly moved, a closed-loop control method in which the position of the magnet unit 520 is sensed and fed back may be used. Therefore, a position sensor 521c may be provided for closed-loop control. The position sensor 521c may be installed adjacent to the center or side of the coil 521b to face the magnet 521a. The position sensor 521c may be installed on the substrate 900 and may be a Hall sensor.

The magnet unit 520 is a moving member that moves along with the base 510 in the optical axis direction, the first direction and the second direction, and the coil 521b is a fixed member fixed to the housing 110.

Since the coil 521b provides driving force to the iris module 500 and is disposed outside the iris module 500, for example, in the housing 110 of the camera module, the weight of the iris module 500 may be reduced.

In detail, since the coil 521b providing driving force to the iris module 500 is provided as a fixing member, the coil 521b does not move during autofocusing or image stabilization operation, and accordingly, an increase in the weight of the lens module 200 due to the adoption of the iris module 500 may be significantly reduced.

In addition, since the coil 521b providing driving force to the iris module 500 is disposed in the housing 110, which is a fixed member, and is electrically connected to the printed circuit board 600, even in the case in which the lens module 200 and the iris module 500 move during autofocusing and image stabilization, the coil 521b of the iris driving unit is not affected.

Therefore, deterioration of the autofocusing function may be prevented.

The base 510 is provided with the movement guide portion 512 on which the magnet unit 520 is disposed. The movement guide portion 512 may protrude from the base 510 in the optical axis direction. The movement guide portion 512 may be provided in a square frame shape such that the magnet unit 520 may be easily seated.

The magnet unit 520 includes a magnet 521a disposed to face the coil 521b and a magnet holder 522 to which the magnet 521a is attached. The magnet 521a is provided to face the coil 521b in a direction, perpendicular to the optical axis direction.

As illustrated, the magnet 521a may be magnetized with three poles along the movement path of the magnet unit 520. For example, as illustrated in FIG. 4, the magnet 521a may be sequentially magnetized to N pole, S pole, and N pole. Of course, although not illustrated, the magnet 521a may also be magnetized to the S pole, the N pole, and the S pole. In addition, although illustration is omitted, the magnet unit 520 may be provided with two separate magnets having an N pole and an S pole, respectively.

In addition, two coils 521b may be disposed facing the magnet 521a, for example, facing each other. As illustrated in FIGS. 5A, 5B, and 5C, the two coils 521b may be provided to face N and S poles on one side and S and N poles on the other side of the magnet 521a, respectively. In this case, among the three poles magnetized, the middle pole is disposed to face both coils. In addition, for example, when the magnet unit 520 is provided with two separate magnets, the coils may be opposed to two separate magnets, respectively.

The magnet unit 520 is disposed on the movement guide portion 512 of the base 510. In addition, a rod member 516 supporting the magnet unit 520 may be provided on the base 510 such that the magnet unit 520 may slide easily. In addition, an insertion groove 525 may be provided in the magnet unit 520 such that the rod member 516 is inserted therein.

The rod member 516 may have a round bar or plate shape to facilitate sliding, and the insertion groove 525 is provided in a cylindrical shape with a smaller diameter than the diameter of the rod member 516 to allow line contact with the rod member 516 to reduce frictional force, or may be provided in a polygonal shape although not illustrated.

In addition, when only the rod member 516 is in contact with the magnet unit 520, since the fixing of the magnet unit 520 is unstable and tilting may occur, a support part may be additionally provided on a portion spaced apart from the rod member 516. For example, a guide blade 517 may be provided on an end of the movement guide portion 512 in substantially parallel with the rod member 516.

The base 510 is provided with a first protrusion 513 that simultaneously penetrates the first guide hole 533 of the first blade 530 and the second guide hole 543 of the second blade 540. The first blade 530 and the second blade 540 rotate around the first protrusion 513.

The magnet holder 522 is provided with a second protrusion 523 penetrating the first blade 530 and the second blade 540.

The second protrusion 523 may be configured to pass through the third guide hole 535 of the first blade 530 and the fourth guide hole 545 of the second blade 540.

On the other hand, the third guide hole 535 and the fourth guide hole 545 may be formed obliquely and long with respect to the moving direction of the magnet unit 520. The inclined directions of the third guide hole 535 and the fourth guide hole 545 may be inclined in opposite directions based on the moving direction of the magnet unit 520.

Therefore, when the magnet unit 520 is moved along one axis, the second protrusion 523 may be moved within the third guide hole 535 and the fourth guide hole 545, and as the second protrusion 523 moves, the first blade 530 and the second blade 540 may move toward the magnet unit 520 or move away from the magnet unit 520 (see FIGS. 5A to 5C).

A holding yoke 515 may be provided in the movement guide portion 512 to face the magnet 521a. The holding yoke 515 may provide a holding force such that the magnet 521a is supported by the movement guide portion 512. The holding yoke 515 may be provided such that the entire area thereof faces the magnet 521a, and may be provided to face both ends of the magnet 521a.

Due to the attractive force between the holding yoke 515 and the magnet 521a, the magnet unit 520 may slide while maintaining close contact with the movement guide portion 512.

In addition, the magnet unit 520, according to the present example, may move in a direction perpendicular to the optical axis direction, and as the magnet unit 520 moves, the first and second blades 530 and 540 rotate to change the size of the entrance hole in three stages (large, medium, and small). Accordingly, when the magnet unit 520 moves to one end of the movement guide portion 512 in a direction perpendicular to the direction of the optical axis, the sizes of the entrance holes or apertures are changed into three types: large, medium, and small. In this state, the state in which the magnet unit 520 is fixed to the three positions of both ends and the middle part of the movement guide portion 512 may be maintained.

In this manner, when the magnet unit 520 moves in a direction perpendicular to the optical axis direction along the movement guide portion 512, the holding yoke 515 may maintain the magnet unit 520 fixed on three positions by attraction force with the driving magnet 521a. For example, even if power is not applied to the coil 521b, a state in which the entrance hole of any one of large, medium, and small sizes are formed may be maintained in a state in which the position of the magnet unit 520 is fixed by the attractive force with the holding yoke 515.

For example, as illustrated in FIG. 4, the iris module 500, according to one or more embodiments, may include a yoke 515 on the base 510. In more detail, the yoke 515 may be provided to face the magnet 521a in the movement guide portion 512 extending in the optical axis direction on the base 510.

In this case, when the magnet unit 520 moves in a direction perpendicular to the optical axis direction along the movement guide portion 512, the yoke 225 may maintain the magnet unit 520 fixed on three positions by attraction with the driving magnet 521a. For example, even if power is not applied to the coil 521b, a state in which an entrance hole of any one of large, medium, and small sizes is formed may be maintained in a state in which the position of the magnet unit 520 is fixed by the attractive force with the yoke 515.

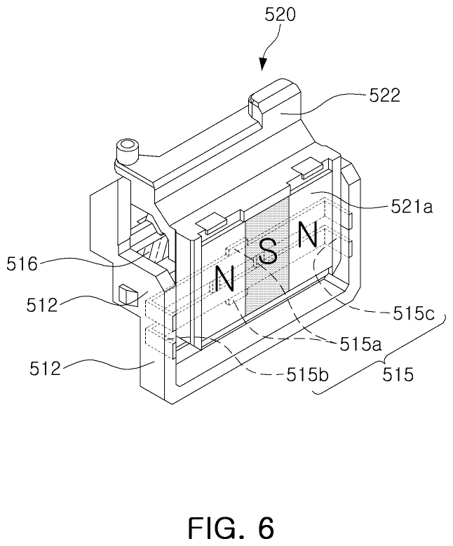

As illustrated in FIG. 6, in one or more embodiments, one expansion portion 515a having a width wider in the optical axis direction than other portions thereof may be provided, to be opposite to the rear surface of the magnet 521a to fix the magnet unit 520 to three positions by attraction with the magnet 521a. The expansion portion 515a may be provided to face between two driving coils 521b.

In addition, two first holding portions 515b and 515c may be provided to extend from the expansion portion 515a to both sides and fixed to the base 510 (the movement guide portion 512) of the iris module 500, to face both side surfaces of the magnet 521a, respectively. Also, the two first holding portions 515b and 515c may be fixed to the movement guide portion 512.

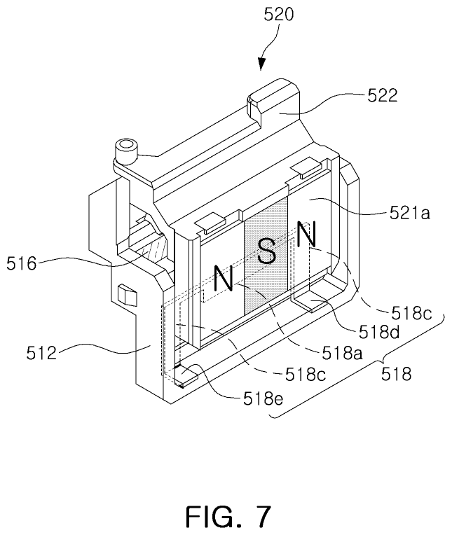

Alternatively, as illustrated in FIG. 7, in one or more embodiments, one expansion portion 518a having a width wider in the optical axis direction than other portions thereof may be provided, to be opposite to the rear surface of the magnet 521a to fix the magnet unit 520 to three positions by attraction with the magnet 521a. The expansion portion 518a may be provided to face between two driving coils 521b.

In addition, two second holding portions 518b and 518c extending from the expansion portion 518a to both sides and then extending in the optical axis direction may be provided. Also, the two second holding portions 518b and 518c may be fixed to a movement guide portion 512.

Furthermore, according to another example, two third holding portions 518d and 518e extending opposite to both side surfaces of a magnet 521a from the two second holding portions 518b and 518c, respectively, may be further provided. Also, the two second holding portions 518b and 518c or third holding portions 518d and 518e may be fixed to the movement guide portion 512.

As set forth above, in the camera module according to one or more embodiments, even when the iris module is installed, the weight increase of the driving unit may be significantly reduced, and thus the performance of the autofocus and image stabilization functions may be maintained.

In addition, the iris module according to one or more embodiments may accurately implement three diaphragm diameters.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An iris module comprising:
a base;
a plurality of blades disposed on the base; and
an iris driving unit comprising a magnet unit configured to linearly reciprocate on the base and drive the plurality of blades,
wherein the magnet unit comprises a driving magnet with an odd number of polarized poles along a movement path of the magnet unit.

2. The iris module of claim 1, wherein the odd number of polarized poles is three.

3. The iris module of claim 1, wherein the plurality of blades is configured to form three different aperture sizes when combined.

4. The iris module of claim 1, wherein a yoke disposed on the base is configured to face the driving magnet along the movement path of the magnet unit.

5. The iris module of claim 4, wherein the magnet unit is fixable to three different positions on the movement path by attractive force between the driving magnet and the yoke.

6. The iris module of claim 5, wherein the yoke has one expansion portion in which a height of a portion opposite to the driving magnet, in an optical axis direction, is greater than heights of other portions.

7. The iris module of claim 6, wherein the expansion portion is disposed in a middle portion of the movement path of the magnet unit.

8. The iris module of claim 6, wherein the yoke has holding portions facing sides of the driving magnet or having a height in the optical axis direction, greater than other portions, on both ends, respectively.

9. A camera module comprising a housing having a lens module, and the iris module of claim 1 coupled to the lens module.

10. A camera module comprising:
a housing having a lens module; and
an iris module, coupled to an upper portion of the lens module, comprising a base, a plurality of blades disposed on the base, and an iris driving unit comprising a magnet unit configured to linearly reciprocate on the base and drive the plurality of blades,
wherein the magnet unit comprises a driving magnet with an odd number of polarized poles along a movement path of the magnet unit, and
driving coils are disposed along the movement path of the magnet unit to face the driving magnet.

11. The camera module of claim 10, wherein the odd number of polarized poles is three.

12. The camera module of claim 10, wherein the driving coils are two driving coils disposed opposite to two poles of the driving magnet, simultaneously and respectively.

13. The camera module of claim 11, wherein a yoke disposed on the base faces the driving magnet along the movement path of the magnet unit.

14. The camera module of claim 12, wherein the magnet unit is fixable to three different positions on the movement path by attractive force between the driving magnet and the yoke.

15. The camera module of claim 13, wherein the yoke has one expansion portion in which a height of a portion opposite to the driving magnet in an optical axis direction is greater than heights of other portions.

16. The camera module of claim 14, wherein the expansion portion is disposed between the two driving coils.

17. The camera module of claim 10, wherein a position sensor configured to sense a position of the magnet unit is disposed in the housing.

18. A camera module comprising:
a housing;
a lens module accommodated in the housing; and
an iris module configured to form three differently sized apertures with a plurality of blades,
wherein on surfaces of the housing parallel to an optical axis direction, a first OIS driving coil is disposed to drive the lens module in a first direction perpendicular to the optical axis direction, a second OIS driving coil is disposed to drive the lens module in the optical axis direction and a second direction perpendicular to the first direction, an AF driving coil is disposed to drive the lens module in the optical axis direction, and two iris driving coils are disposed to drive the plurality of blades, respectively.
